(19) United States
(12) Patent Application Publication
(10) Pub. No.: US 2010/0205448 A1
(43) Pub. Date: Aug. 12, 2010

(54) DEVICES, SYSTEMS AND METHODS FOR SECURE VERIFICATION OF USER IDENTITY

(76) Inventors: Tolga Tarhan, Irvine, CA (US); Amir Kashani, Mission Viejo, CA (US); Akito Nozaki, Irvine, CA (US); Eric Poulsen, Aliso Viejo, CA (US); Matthew D. Hetland, San Clemente, CA (US); Rabih Zahr, Siverado, CA (US); Nedal Makarem, Newport Beach, CA (US); Kirk Waldfogel, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/369,638

(22) Filed: Feb. 11, 2009

(51) Int. Cl. G06F 21/00

(52) U.S. Cl. 713/185

(57) ABSTRACT

In one embodiment, devices, systems, and methods provide authentication of a user using two-factor authentication to enhance security. In such embodiment, a user presents login information and a valid token, wherein the token may be generated by a portable authentication device that comprises a processor, a memory, and/or an activation interface.

### BACKGROUND

1. Field of the Invention

The present invention relates generally to systems and methods of user verification. More particularly, the invention relates to systems and methods of secure verification of user identity.

2. Description of the Related Art

With the explosive growth of the Internet, the demand for secure verification of user identities has increased. Users are conducting more and more types of business online, such as shopping, banking, and investing. Accordingly, businesses want to be able to verify the identity of a user visiting their website. However, password logons are prone to theft and copying.

### SUMMARY OF THE DISCLOSURE

In some embodiments, a portable authentication device is disclosed. The portable authentication device may include: a memory configured to store a token encryption key, a random number encryption key, a random number seed, a user identification number, a sequence number, a device identification number, and an activation interface configured to be activated by a user; an activation interface module stored in the memory and configured to receive an indication that the authentication device is electronically connected to a computer and the activation interface has been activated; a token generation module stored in the memory and configured to run on the computer after the authentication device has been electronically connected to the computer, the module including instructions to create a random number using the random number encryption key and the random number seed, update the sequence number, encrypt the random number, the user identification number, and the sequence number using the token encryption key to create a set of encrypted data and a checksum, and create a token, the token comprising the device identification number, the set of encrypted data, and the checksum.

In another embodiment, a computer-implemented method for electronically generating an authentication token is disclosed. The method may include: receiving a random number encryption key, a token encryption key, a random number seed, a user identification number, a sequence number, and a device identification number from a portable authentication device; creating, by a processor, a random number using a the random number encryption key and the random number seed; updating, by a processor, the sequence number; encrypting, by a processor, the random number, the user identification number, and the sequence number using the token encryption key to create a set of encrypted data and a checksum; and creating, by a processor, a token, the token comprising the device identification number, the set of encrypted data, and the checksum.

In a further embodiment, an authentication server system is disclosed. The authentication server system may include a memory; and an authentication module stored on the memory, the authentication module configured to receive an authentication token, the authentication token comprising a device identification number and a set of encrypted data, use the device identification number to retrieve a token encryption key, decrypt the set of encrypted data using the token encryption key to obtain a random number, a user identification number, and a sequence number, verify the sequence number is valid, verify the random number is correct, and verify the user identification number is correct.

In an additional embodiment, a computer-implemented method for electronically authenticating a token is disclosed. The method may include: receiving an authentication token generated by a portable authentication device, the authentication token comprising a device identification number and a set of encrypted data; using the device identification number to retrieve a token encryption key; decrypting the set of encrypted data using the token encryption key to obtain a random number, a user identification number, and a sequence number; verifying the sequence number is valid; verifying the random number is correct; and verifying the user identification number is correct.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

Embodiments of a general architecture that implements the various features of the invention will be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1A illustrates a high-level block diagram of one embodiment of a user authentication system.

FIG. 1B illustrates a high-level block diagram of another embodiment of a user authentication system.

FIG. 1C illustrates a high-level block diagram of another embodiment of a user authentication system.

FIG. 2A illustrates a flowchart of one embodiment of an authentication process.

FIG. 2B illustrates a flowchart of another embodiment of an authentication process.

FIG. 3 illustrates a flowchart of one embodiment of a token generation process.

FIG. 4 illustrates a flowchart of one embodiment of a token validation process.

FIG. 5 illustrates a flowchart of one embodiment of a device initialization process.

FIG. 6A illustrates a perspective view of an embodiment of an authentication device.

FIG. 6B illustrates a perspective view of another embodiment of an authentication device.

FIG. 7 illustrates a high-level block diagram of one embodiment of an authentication device.

FIG. 8 illustrates a high-level block diagram of one embodiment of a computing system.

### DETAILED DESCRIPTION OF PREFERRED EMBODIMENTS

The features of the systems and methods will now be described with reference to the drawings summarized above. The methods and functions described herein are not limited to any particular sequence, and the blocks or states relating thereto can be performed in other sequences that are appropriate. For example, described blocks or states may be performed in an order other than that specifically disclosed, or multiple blocks or states may be combined in a single block or state.

Conditional language, such as, among others, “can,” “could,” “might,” or “may,” unless specifically stated otherwise, or otherwise understood within the context as used, is generally intended to convey that some embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

For purposes of illustration, some embodiments will be described in the context of an Internet webpage and application. However, the present disclosure is not limited by the type of environment in which the systems and methods are used as the systems and methods may be used in other environments, such as, for example, the Internet, the World Wide Web, a private network, an internal network of a corporate enterprise, an intranet, a local area network, a wide area network, and so forth. It is also recognized that in other embodiments, the systems and methods may be implemented as a single module and/or implemented in conjunction with a variety of other modules and the like. Moreover, the specific implementations described herein are set forth in order to illustrate, and not to limit, the invention.

### I. Overview

In one embodiment, devices, systems, and methods provide authentication of a user using two-factor authentication to enhance security. In such embodiment, a user presents login information and a valid token to an application for validation, wherein the token may be generated by a portable authentication device. In order to compromise the user's account, a third party would have to obtain the user's portable authentication device and determine the user's login information.

The portable authentication device may be implemented using a simple, cost efficient device that is programmed to generate secure authentication tokens. The portable authentication device may include a processor, a memory, and/or an activation interface and may be programmed to provide additional features such as being able to emulate a memory device and/or to emulate an input device.

For purposes of summarizing the invention, certain aspects, advantages, benefits, and novel features of the invention are described herein. It is to be understood that not necessarily all such advantages or benefits may be achieved in accordance with any particular embodiment of the invention. Thus, for example, those skilled in the art will recognize that the invention may be embodied or carried out in a manner that achieves one advantage or group of advantages as taught herein without necessarily achieving other advantages or benefits as may be taught or suggested herein.

### II. Sample Operation

For purposes of illustration, a sample scenario will now be discussed in which one embodiment of the system is used in operation. In this sample scenario, the system is used by a customer of a bank to access his online bank account. Such access is advantageous since online banking provides convenience to the customer and is easy to use. As such, it allows customers to do their banking from the comfort of their own home, pay bills without having to write checks, and have 24 hour access to their accounts. In addition, banks often prefer online banking because it reduces the volume of paper statements they have to send to their customers and due to the lower costs of electronic transaction processing.

Returning to the scenario, the customer decides he wants to access his online bank account and connects his portable authentication device to his computer the computer uses his computer to visit the website of his bank using a web browser on his computer. The bank's server receives the customer's request and initiates a two-factor authentication process to authenticate the customer. During a previous initialization process, the portable authentication device is associated with the customer.

For the first factor, the bank's server verifies that the customer's portable authentication device is a valid device. For example, after the customer connects his portable authentication device to his computer, his device automatically generates an authentication token that uniquely identifies the device and passes the token to the host computer. The host computer incorporates the token into a uniform resource locator (“URL”), sends the URL to the bank's server. The bank's server receives the URL, extracts the token, and forwards it to an authentication server for validation. The authentication server verifies whether the token is valid. If the token is invalid, the server marks the authentication device as stolen in its records and reject's the customer's request to access the account. However, if the token is valid, the authentication server authenticates the token and notifies the bank's server that the token is valid. The bank's server then proceeds with the second part of the authentication process.

For the second factor, the bank's server verifies that the customer's password is valid. For example, after receiving an indication that the token is valid, the bank's server sends the customer's computer a webpage with a prompt for login information, such as a user name and/or a password. The customer's computer displays this page, allows the customer to enter his login information, and sends the login information to the bank's server. The bank's server then checks to see whether the login information is valid. If the login information is invalid, the bank's server may give the customer one or more chances to re-submit his information and if the customer fails several times, the bank's server may disable the requested account and notify the customer that his account has been disabled. If the login information is valid, the bank's server allows the customer to access his online bank account.

While the scenario above involves authentication for an online banking session, it is recognized that this example is used only to illustrate features of one embodiment of a system. Accordingly, the system may be used in other environments and may be used with other types of and/or combinations of online systems, applications, web applications or the like, comprising, for example, tax programs, accounting programs, investment sites, e-commerce sites, multi-player games, subscriber-based applications, or any application that uses a password.

### III. User Authentication System

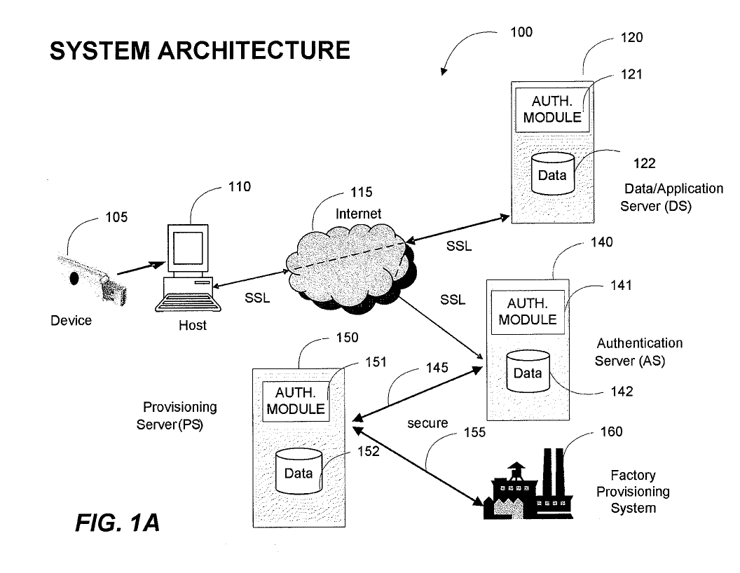

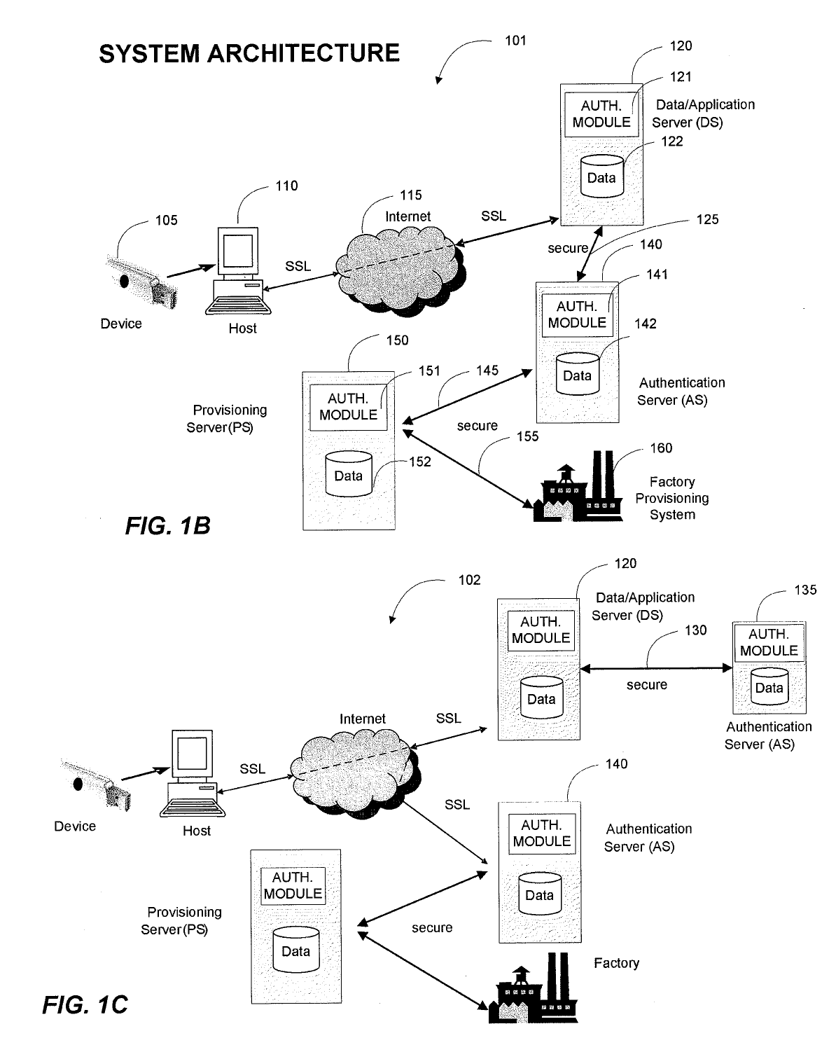

FIG. 1A illustrates one embodiment of a user authentication system 100 operating among a plurality of computing systems, such as, an authentication device 105, a host computer 110, an application server 120, an authentication server 140, a provisioning server 150, and a provisioning system 160 in a factory, wherein these systems communicated using one or more communication mediums 115, 145, 155, such as, the Internet, a direct network connection, and/or a wireless network connection using a communication protocol, such as, the secure socket layer (SSL) protocol, transport layer security (TLS) protocol, and/or other protocols.

In the illustrated authentication system 100, the authentication device 105 is connected to the host computer 110; the host computer 110 communicates with the application server 120 via the Internet using SSL; the application server 120 communicates with the authentication server 140 via the Internet using SSL; the authentication server 140 communicates with the provisioning server 150 via a direct, secure connection; and the provisioning server 150 communicates with the provisioning system 160 via a direct, secure connection.

In certain embodiments, a secure connection, such as communication medium 145, 155, may be via the Internet using a secure communication protocol. In some embodiments, one or more of the systems may be combined. For example, the authentication server 140 and provisioning server 150 can be the same server, and/or the application server 120 and authentication server 140 can be the same server.

a. Authentication Device

The illustrated authentication system 100 includes a portable authentication device 105 used to generate authentication tokens for verification by the authentication server 140. The portable authentication device 105 may be a USB storage device, and may generate cryptographically strong one-time use tokens that are not repeated. In some embodiments, the user carries the portable authentication device with him so that when he wants to access a secure account, the user can connect the authentication device to the computer he is using to access the account. The authentication device 105 is discussed in detail further below.

While FIG. 1A illustrates one embodiment of an authentication device 105, it is recognized that other embodiments may be used. For example, the authentication device 105 may connect with the host computer using wireless communication.

b. Host Computer

The illustrated authentication system 100 also includes a host computer 110 that allows the user to communicate with the application server 120. The illustrated host computer 110 is a computing system that includes an interface for communicating with the authentication device 105.

The host computer 110 may also include a browser module that uses text, graphics, audio, video, and other media to present data to the user. Accordingly, the browser module may include software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module may communicate with a set of input and output devices to send and/or receive signals from the user.

While FIG. 1A illustrates one embodiment of host computer 110, it is recognized that other embodiments may be used. For example, the authentication device 105 may communicate with the host computer 110 using wireless communication.

c. Application Server

The illustrated authentication system 100 also includes an application server 120 used to verify user information and transfer authentication tokens to an authentication server 140. The illustrated application server 120 is a computing system that includes an authentication module 121 and a data source 122 that stores user information. The authentication module 121 is programmed to process authentication tokens received from the authentication device 105 via the host computer 110, such as by extracting the token from information received from the host computer 110, such as a URL, and to send the token to the authentication server 140. The authentication module 121 is also programmed to compare the login information submitted by a user with the corresponding login information stored in the data source 122. The information stored in the data source may include user passwords, account information, user names, and/or the like.

While FIG. 1A illustrates one embodiment of an application server 120, it is recognized that other embodiments may be used. For example, some or the entire the data source 122 may be external to the application server 120 and/or the application server 120 may comprise a plurality of servers forming a cluster. A cluster implementation would increase redundancy and/or availability of the application server 120.

d. Authentication Server

The illustrated authentication system 100 also includes an authentication server 140 that receives tokens from the application server 120 and authenticates the tokens to determine whether the tokens are valid. The illustrated authentication server 140 is a computing system, which includes an authentication module 141, and a data source 142 that stores data regarding the authentication devices 105. For example, the data source 142 may store one or more encryption keys, decryption keys, seeds, random number generators, identification numbers, counters, sequence numbers, device identification numbers, MAC addresses, program modules, nonces, user information, web addresses, URLs, server locations, time, account information, firmware, and/or other data. In some embodiments, the stored information comprises a token encryption key, a random number encryption key, a random number seed, a user identification number, a sequence number, a device identification number, a nonce encryption key, and/or a nonce seed.

While FIG. 1A illustrates one embodiment of an authentication server 140, it is recognized that other embodiments may be used. For example, some or the entire the data source 142 may be external to the authentication server 140 and/or the authentication server 140 may comprise a plurality of servers forming a cluster. A cluster implementation would increase redundancy and/or availability of the authentication server 140.

e. Provisioning System

The illustrated authentication system 100 also includes a provisioning system 160, used to create the authentication devices 105 and to load data onto the authentication devices 105. The provisioning system 160 communicates with the provisioning server 150 to retrieve the data that is loaded onto the authentication devices 105 and transmit to the provisioning server information that indicates the data was loaded for each particular authentication device 105. In addition, the provisioning system 160 may exchange data with the provisioning server 150 in real-time and/or by batch processing. The illustrated provisioning system 160 is a computing system that includes a load module.

The loaded data may include similar data as that stored in the authentication server's data source 142 such as a token encryption key, a random number encryption key, a random number seed, a user identification number, a sequence number, a device identification number, a nonce encryption key, a nonce seed, a URL, a firmware, an activation interface module and/or a token generation module. The data transmitted to the provisioning server 150 may include keys, seeds, device ID's, serial numbers and/or other data. The provisioning system 160 may also associate a serial number for an authentication device with a device ID.

While FIG. 1A illustrates one embodiment of a provisioning system 160, it is recognized that other embodiments may be used. For example, some or the entire data source may be external to the provisioning system 160 and/or the provisioning system 160 and all or part of the provisioning server 150 may be combined. In addition, the provisioning system 160 may load additional and/or different information, such as encryption keys, decryption keys, seeds, random number generators, identification numbers, counters, sequence numbers, device identification numbers, MAC addresses, program modules, nonces, user information, web addresses, URLs, server locations, time, account information, firmware, and/or other data.

f. Provisioning Server

The illustrated authentication system 100 also includes a provisioning server 150 that stores data to be loaded onto the authentication devices 105 by the provisioning system 160 and receives data indicating which data is stored on each of the authentication devices 105. The provisioning server 150 may also communicate with the authentication server 140 to provide authentication information for the authentication server's authentication devices 105. The provisioning server 150 may communicate with the provisioning system 160 and/or the authentication server 140 in real-time and/or by batch processing. The illustrated provisioning server 150 is a computing system, which includes an authentication module 151 and a data source 152 that stores the initialization information.

In some embodiments, the provisioning server 150 sends information to the provisioning system 160 for storage on the authentication devices 105, such as a token encryption key, a random number encryption key, a random number seed, a user identification number, a sequence number, a device identification number, a nonce encryption key, a nonce seed, a URL, a firmware, an activation interface module and/or a token generation module. In addition, the provisioning server 150 receives information from the provisioning system 160 indicating which keys, seeds, and identification numbers are assigned to which authentication devices 105, which authentication devices 105 have been distributed from the factory, and/or which authentication devices have not yet been initialized.

While FIG. 1A illustrates one embodiment of a provisioning server 150, it is recognized that other embodiments may be used. For example, some or the entire data source 152 may be external to the provisioning server 150 and/or the provisioning server 150 may comprise a plurality of servers forming a cluster. A cluster implementation would increase redundancy and/or availability of the provisioning server 150. In addition, the provisioning server 150 may store additional and/or different information, such as encryption keys, decryption keys, seeds, random number generators, identification numbers, counters, sequence numbers, device identification numbers, MAC addresses, program modules, nonces, user information, web addresses, URLs, server locations, time, account information, firmware, and/or other

g. Additional User Authentication Systems

FIG. 1B illustrates a high-level block diagram of another embodiment of the user authentication system 101. In the user authentication system 101, a data server 120 is directly connected to an application server 140 via a secure connection 125. The secure connection 125 may be via a network, fiber optic cable, and/or the like.

FIG. 1C illustrates a high-level block diagram of another embodiment of the user authentication system, where a second authentication server 135 is directly connected to the application server 120 via a network, fiber optic cable, and/or the like. The second authentication server 135 can serve as a backup authentication server or a master authentication server while authentication server 140 may only be able to authenticate a subset of devices.

### IV. User Authentication Device

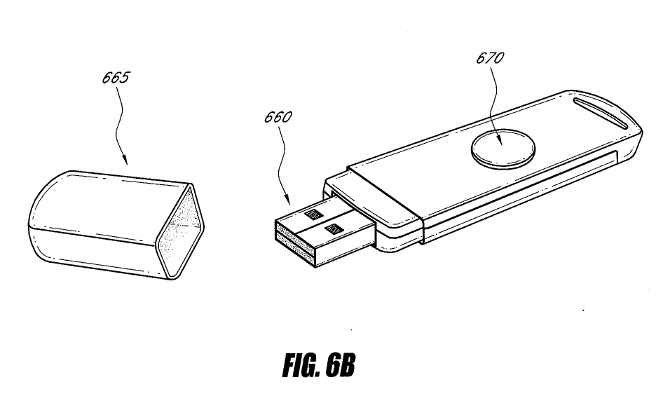

FIG. 6A illustrates one embodiment of the authentication device 105 of FIG. 1A. The illustrated authentication device is configured to be electronically connected to a host computer through a USB connector 610, such as a half-height connector wherein the metal cover surrounding the contact points have been removed. In some embodiments, the connector includes an interface, such as IEEE 1394, serial, parallel, eSATA, and/or the like. In other embodiments, a wireless connection can be used, such as Bluetooth®, 802.11a/b/g/n, and/or the like. FIG. 6B illustrates another embodiment of the authentication device that includes a cap 665 to protect the USB connector and a button 670 to allow user input.

In some embodiments, the authentication device 105 is configured to operate without the need for a driver on the host computer 110 by emulating an input device, a mass storage device, such as an external hard drive, flash drive, and/or optical drive, and/or other device that a host computer can recognize without drivers. In certain embodiments, drivers and/or software may be provided to enable communication between the authentication device 105 and the host computer 110 without using emulation.

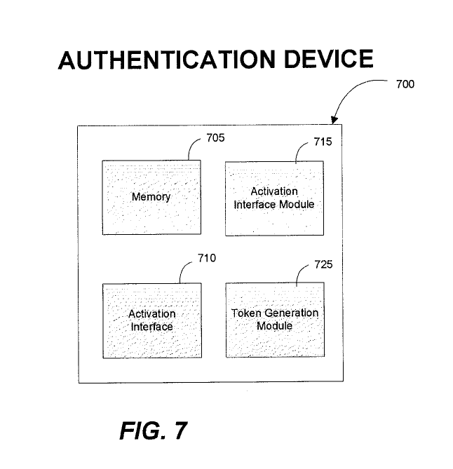

FIG. 7 illustrates one embodiment of an authentication device that includes a memory 705, an activation interface 710 to be activated by a user, an activation interface module 715 for tracking activation of the activation interface, and a token generation module 725 for generating tokens. In certain embodiments, the activation interface 710 and token generation module 725 are stored in memory separate from memory 705. In other embodiments, the activation interface 710 and token generation module 725 are stored in memory 705.

a. Memory

The illustrated authentication device 105 includes a memory, such as SDRAM, EEPROM, flash, non-volatile memory, volatile memory, a hard drive, an optical drive, and/or a combination of the above. The memory is configured to store one or more encryption keys, decryption keys, seeds, random number generators, identification numbers, counters, sequence numbers, device identification numbers, MAC addresses, program modules, nonces, user information, web addresses, URLs, server locations, time, account information, firmware, and/or other data. In some embodiments, the stored information comprises a token encryption key, a random number encryption key, a random number seed, a user identification number, a sequence number, a device identification number, a nonce encryption key, a nonce seed, a URL, a firmware, an activation interface module and/or a token generation module. In some embodiments, no user data, such as logons, passwords, personal information, account information and/or the like, is stored on the device for enhanced security.

b. Activation Interface

The illustrated authentication device 105 also includes an input device or activation interface that allows a user to activate the authentication device. In some embodiments, the activation interface is a button 620. In some embodiments, the activation interface is a switch, finger print scanner, and/or other biometric data reader, touch pad, toggle, input device and/or the like.

c. Activation Interface Module

The illustrated authentication device 105 also includes an activation interface module 715 stored in memory. The activation interface module 715 determines when the activation interface has been activated and/or may record the time and/or duration that the activation interface is activated. The time can be recorded in hours, minutes, seconds, deciseconds, centiseconds, milliseconds, microseconds, nanoseconds, picoseconds, and/or other intervals. In addition, the activation interface module 715 may be used to call or activate the token generation module 725 to create a token.

d. Token Generation Module

The illustrated authentication device 105 includes a token generation module 725 stored in memory. In some embodiments, the token generation module 725 runs on a host computer 110 after the authentication device is connected to the host computer 110. The host computer 110 uses the token generation module and the data stored on the authentication device 105 to generate authentication tokens via a token generation process 300. In other embodiments, the token generation module runs on the authentication device 105.

In some embodiments, the token generation module 725 runs automatically after the authentication device 105 is connected to a host computer 110 by emulating a storage drive on the host computer 110, such as a CD-Rom, hard drive, and/or flash drive. Thus, when the authentication device 105 is connected to the host computer 100, the operating system on the host computer automatically launches the token generation module 725 stored on the authentication device 105.

In one embodiment, the token generation module 725 creates a URL that comprises the authentication token and a web site address such that when the token generation process runs, it automatically opens a web browser and goes to the web page address. The web page address may be stored on the authentication device 100 at the factory or it may be stored by the host computer 10. The authentication device 105 may store one or more web addresses allowing the user and/or host computer 110 to select one of the addresses from the group. In other embodiments, the token generation module 725 generates other output such as the location of the application server 120 and/or authentication server 140.

The token generation module 725 may also emulate keystrokes, mouse movement, and/or other input devices to automatically send information to the host computer.

e. Processor

The authentication device may also include a processor, such as an embedded processor as well as a data and code protection module configured to prevent unauthorized reading and writing of the memory on the authentication device 105.

f. Power Source

In some embodiments, the authentication device 105 does not have its own power source, but instead draw power from its connection with a host computer. In other embodiments, the authentication device 105 includes a power source, such as a battery, that can power a wireless connection, memory, processor and/or input device.

### V. User Authentication System Methods

To perform the two-factor authentication, the user authentication system 100 may include a user authentication process comprising an auto-run process 200, a user authentication process 2900, a token generation process 300, a token authentication process 400, and/or a device initialization process 500.

a. User Authentication Process

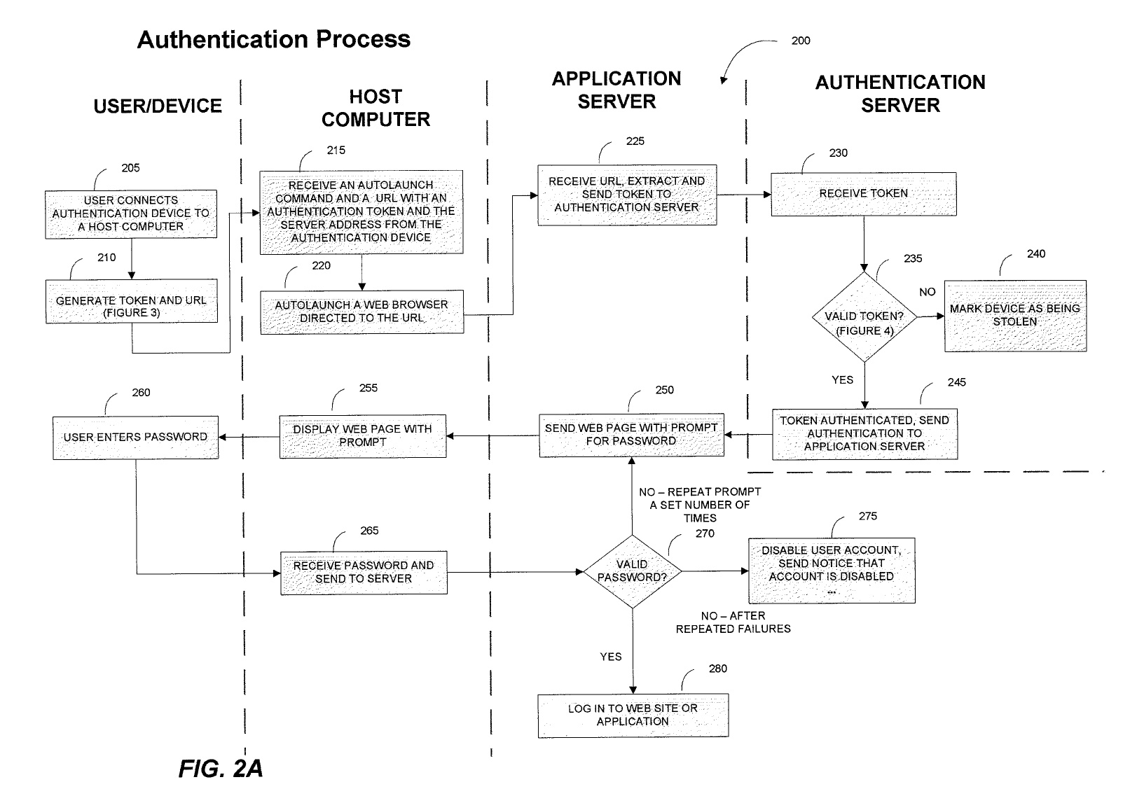

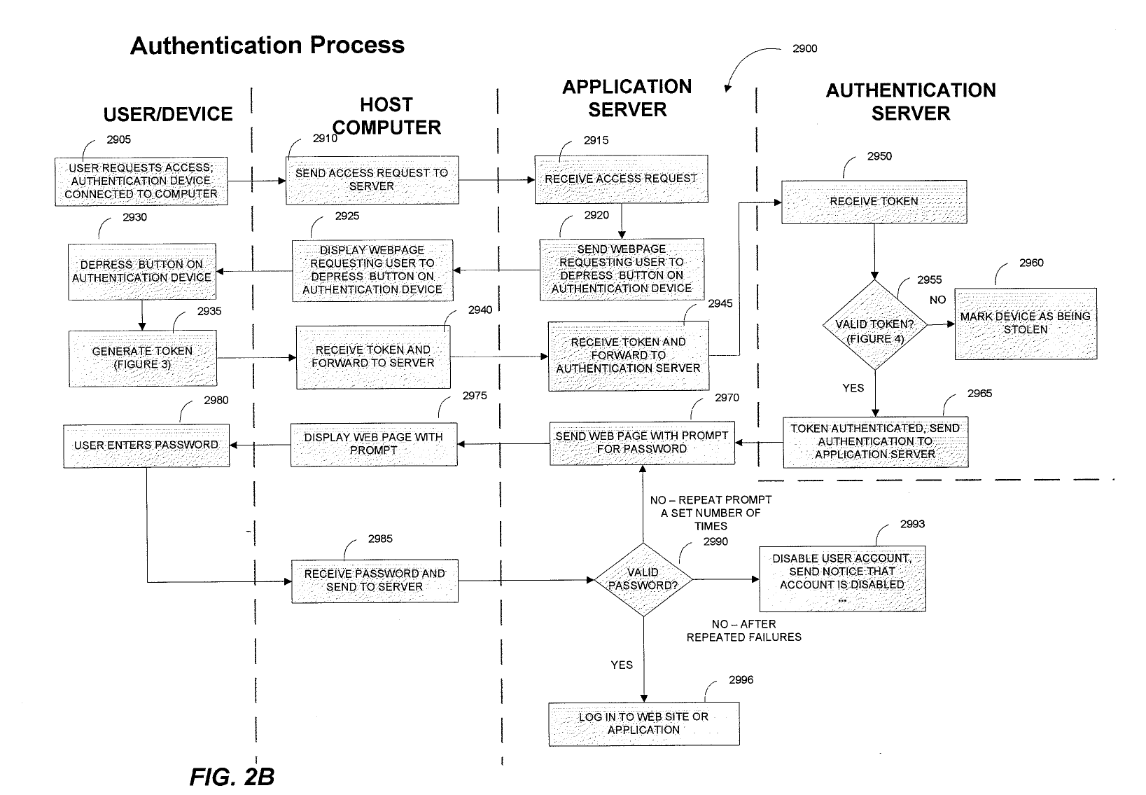

In some embodiments, the user authentication process comprises an auto-run process 200 and/or a user activation interface process 2900. As shown in FIGS. 2A and 2B, the user authentication processes comprises multiple processes that run on the authentication device 105, host computer 110, the application server 120, and the authentication server 140.

i. Auto-Run Process

FIG. 2A illustrates a flowchart of one embodiment of an auto-run process. Beginning at block 205, a user connects an authentication device 105 to a host computer 110, where the token generation process 300 is stored on the authentication device 105 and is programmed to automatically run after the authentication device 105 is connected to the host computer 100. At block 210, the token generation process 200 generates an authentication token and embeds the token into a URL. In the embodiment of FIG. 2A, the activation interface 710 is not activated before the authentication token is generated and sent. In some embodiments, the activation interface 710 may be used for any additional authentications without having to reinsert the device.

At block 215, the host computer 110 receives an auto-launch command and the URL, which includes the authentication token. The host computer 110 then opens a web browser and sends a request to the application server 120 for the web page corresponding to the URL. In other embodiments, the host computer 110 communicates with an application server 120 and/or authentication server 140 directly, without using a web browser.

At block 225, the application server 120 receives the URL from the host computer 110 extracts the token, and sends the token to the authentication server 140.

At block 230, the authentication server 140 receives token from the application server 120 and validates the token using the token validation module 400.

At block 240, if the token is invalid, the authentication device 105 is marked as stolen, disabling further use of the authentication device 105. The authentication server 140 may also notify the application server 120 that the token is invalid, and the application server 120 denies the user access to the requested account. The application server 120 may send the host computer 110 a web page that indicates that an error has occurred or that the user is banned from the account.

If the token is valid at block 245, the authentication server 140 sends a message to the application server 120 that the token is valid.

At block 250, the application server begins the second part of the authentication which uses login information, such as user name and a password. The application server 120 sends a web page with a prompt for a user name and/or a password to the host computer 110. At block 255, the host computer displays the web page with the prompt.

At block 260, the user submits his login and/or password to the host computer 110. At block 265, the host computer 110 receives the login and/or password and sends the password to the application server 120. At block 270, the application server 120 retrieves a stored login and/or password from its data source and compares it with the received login and/or password received from the host computer 110. If the password is invalid, the application server 120 disables the user account and sends a notification to the user and/or system administrator that the account has been disabled (block 275). In some embodiments, the application server 120 gives the user additional chances to enter a valid password, to account for an inadvertent mistake by the user in inputting his password. However, the application server 120 may place a cap on the number of attempts to prevent brute force password guessing and other types of hacking. In some embodiments, the range of chances can be 1-20. In other embodiments, the range can be 2-5. In some embodiments, more than 20 chances can be given. If multiple chances are given and the application server 120 determines that the password is invalid, at block 250 the application server 120 provides the host computer 110 with another page with a login and/or password prompt. This cycle may be repeated until the limit is reached or a valid password is received.

At block 280, a valid password is received and the application server 120 allows the user to access the requested website, account, and/or application. In certain embodiments, the application server 120 allows access to the application and directs host computer 110 to the application page.

ii. User Activation Interface Process

FIG. 2B illustrates a flowchart of one embodiment of a user activation interface process 2900 which is triggered by activation of the activation interface on the authentication device by the user. In some embodiments, activation could comprise pressing a button on the authentication device.

Beginning at block 2905, a user requests access to a web site and/or an application by entering a URL in a web browser, clicking an icon, running a program, and/or some other user-initiated action. In some embodiments, the host computer 110 receives an auto-launch command and the URL without an authentication token from a connected authentication device, and the user authenticates by further activating the authentication device 105. In certain embodiments, the host computer 110 receives an auto-launch command and the URL with only the device ID but not a full authentication token from a connected authentication device; thus the application server 120 knows the asserted identify but further requests validation of that identify by having the user activate the authentication device 105.

At block 2910, the host computer 100 receives the access request and sends that requests to the application server 120. At block 2915, the application server 120 receives the access request, and at block 2920, the application server 120 sends a web page to the host computer 110 instructing the user to ensure that the activation device 105 is connected to the host computer 110 and to activate the authentication device 105, such as by pressing a button on the activation device 105. In some scenarios, the authentication device 105 may already be connected to the host computer 110 before the user sends the request.

At block 2925, the host computer 110 displays the web page to the user, and at block 2930, the user activates the authentication device 105, such as by pressing the button on the activation device 105.

At block 2935, the token generation module on the authentication device 105 generates a token, and the authentication device 105 emulates a keyboard and sends the generated token to the host computer 110. In some embodiments, the token generation module also generates a URL that comprises the authentication token and an address, such as a web address and/or an application server address, and sends the URL to the host computer 110 instead of or in addition to the token. In some embodiments, the authentication device 105 is configured to emulate keystrokes, mouse movement, and/or other input devices allowing it to automatically send information to the host computer 110. In certain embodiments, drivers and/or software may be provided to enable communication between the authentication device 105 and the host computer 110 without using emulation.

At block 2940, the host computer 110 sends the authentication token (and other information) to the application server 120.

At block 2945, the application server 120 receives the URL from the host computer 110, extracts the token from the URL, and sends the token to the authentication server 140 for authentication.

At block 2950, the authentication server 140 receives the token from the application server 120. At block 2955, the authentication server validates the token by running the token validation process 400 and continues in a similar manner as in FIG. 2A.

In other embodiments, the authentication device 105 can be activated without a prompt.

b. Token Generation Process

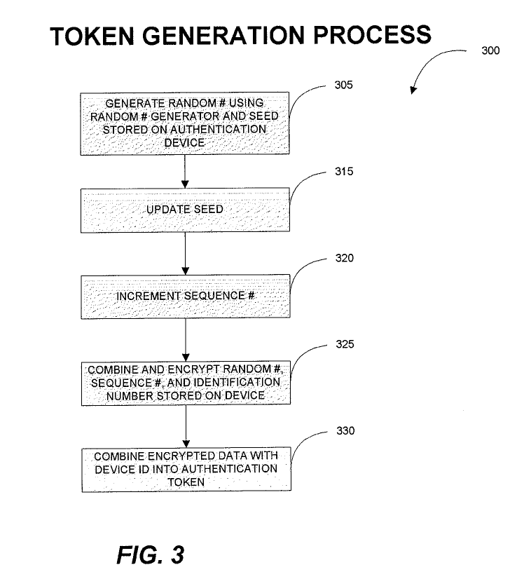

FIG. 3 illustrates a flowchart of one embodiment of the token generation process 300 that may be stored on the authentication device 105. Beginning at block 305, the token generation process 300 generates a random number using a random number generator along with an encryption key and a seed stored on the authentication device 105, where the encryption key and the seed are input to the random number generator and an updated seed is output with the random number. In some embodiments, the token generation process also generates a random nonce using a nonce encryption key and a nonce number seed stored on the authentication device 105. The random nonce can be used in encryption schemes such as AES-CCM and/or other encryption schemes used to encrypt data.

At block 315, the token generation process 300 stores on the authentication device 105 any updated seeds generated by the random number generators.

At block 320, the token generation process 300 updates or increments a sequence number stored on the authentication device 105.

At block 325, the token generation process 300 combines the generated random number with the incremented sequence number and/or the user identification number of the authentication device 105. The user identification number can be a substantially unique number generated by an arbitrary user action, and is described in further detail below. In some embodiments, this data is concatenated. The combined data is then encrypted. The encryption may use a token encryption key, the generated random nonce, as well as other data stored on the authentication device 105 and may output a set of encrypted data as well as a checksum. In some embodiments, the checksum is a cipher block chaining message authentication code (CBC-MAC).

At block 330, the encrypted data is combined with the device ID of the authentication device 105 to create a token, where the device ID is an identification value uniquely identifying the authentication device. The token may also include the checksum and a nonce.

c. Token Validation Process

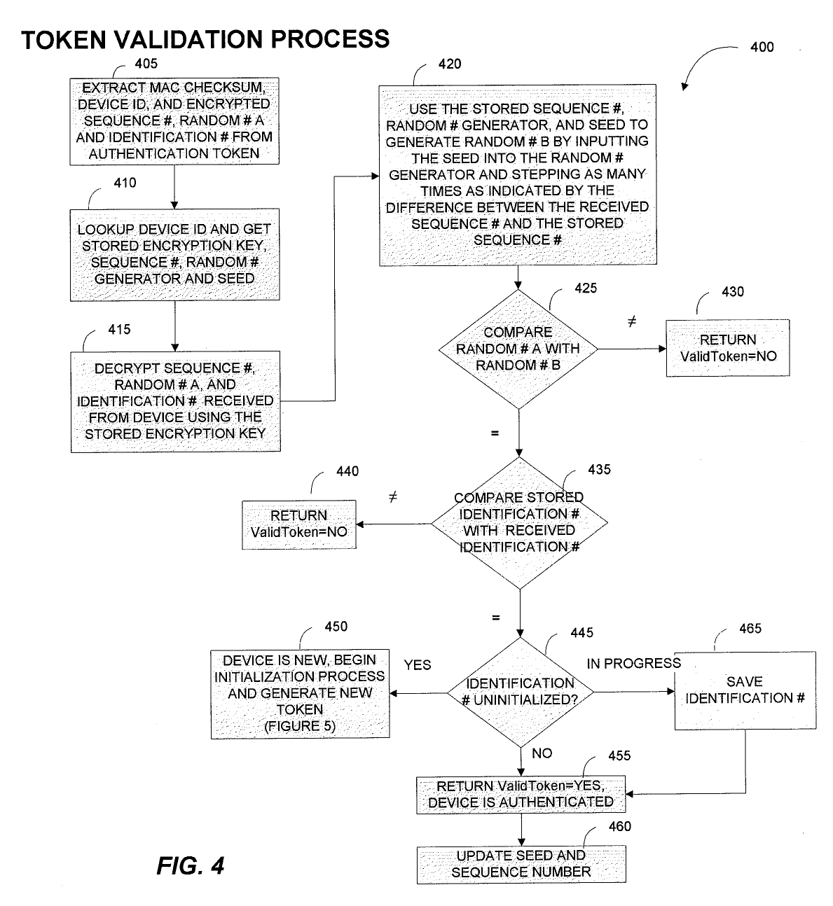

FIG. 4 illustrates one embodiment of a token validation process 400 used to determine whether a token is valid and/or whether a device needs to be initialized. In some embodiments, the token validation module is called during the authentication process to validate a token.

Beginning at block 405, the token validation process 400 extracts a checksum, a nonce, a device ID, a sequence number, a random number, and/or user identification number from the received authentication token. Some or all of the data may be encrypted. For example, in some embodiments, the sequence number, random number, and/or user identification number are encrypted.

At block 410, the token validation process 400 communicates with the data source 142 to look up the device ID and/or retrieve the stored token encryption key, sequence number, random number generator or random number encryption key, and random number seed. The stored encryption keys are the same as the encryption keys on the authentication device, and the stored sequence number and/or random number seed represent the last value known by the user authentication system 140 to have been used by the authentication device 105.

At block 415, the token validation process 400 decrypts the sequence number, random number, and/or user identification number, received from the device using the stored token encryption key and the received nonce. In some embodiments, when the token validation process 400 decrypts the encrypted data, a checksum is verified. If the checksum is correct, the process continues to the next block. If the checksum is incorrect, the token validation process 400 reports an invalid token or requests a new token. In other embodiments, the token validation process 400 generates a checksum separate from the decryption process.

The token validation process 400 checks whether the stored sequence number is less than the received sequence number to determine whether the received token is a replay of a previously sent token. This can prevent attacks on the authentication system that use captured previous instances of tokens.

At block 420, the received sequence number can be compared with the stored sequence number to determine the number of iterations to go through in order to generate a matching second random number based on the last time the token validation process was run. In one embodiment, the difference between the sequence numbers determines the number of iterations to use. In some embodiments, the difference may be offset by 1, depending on whether the token was generated before or after the received sequence number was incremented. The token validation process may also use the stored random number encryption key and the stored random number seed to generate a random number and can repeat this process to iterate through generated random numbers for a number of times, as indicated by the sequence number comparison. For example, if the stored sequence number is 8 and the token's sequence number is 12, then the random number generator may run four times before generating the final random number. The final generated random number should match the received random number from the token.

At block 425, the token validation process 400 compares the generated random number and the received random number. If the numbers are not the same, the token validation process proceeds to block 430 and reports that the token is invalid and completes running. If the numbers are equal, the token validation process proceeds to block 435.

At block 435, the token validation process 400 determines whether the user identification number is valid. The authentication device 105 comes from the factory with the user identification number un-initialized and, in some embodiments, the user identification number is un-initialized if it equals zero or other preset data value. In other embodiments, a user identification number is un-initialized if it equals a specified, non-zero number. The value denoting an un-initialized state can be stored on an authentication server. In some embodiments, regardless of whether the number is initialized or un-initialized, the stored user identification number and the received identification number should match if the token is valid. The token validation process 400 compares the identification numbers, and if the received user identification number is correct, the token validation process proceeds to block 445. If the received user identification number is invalid, the token validation process 400 proceeds to block 450 and reports that the token is invalid and completes running.

At block 445, the token validation process 400 determines if the user identification number is un-initialized. If the user identification number is un-initialized, the token validation process 400 proceeds to block 450. If the number is initialized, the token validation process 400 proceeds to block 455. If the user identification number is in the process of initialization, the token validation process 400 proceeds to block 465.

At block 450, the authentication device 105 is un-initialized via an initialization process 500. The token validation process 400 then resumes after the initialization process 500 is completed.

At block 455, the authentication device 105 has already been initialized and the token validation process 400 reports that the token is valid. At block 460, the stored seed number and/or stored sequence number are updated. In some embodiments, the stored sequence number are updated by setting the received sequence number as the new stored sequence number and storing the new seed number. The token validation process 400 completes after the seed and sequence number are updated. In addition, the token validation process 400 may set the received user identification number as the stored identification number and proceeds to block 455.

d. Device Initialization Process

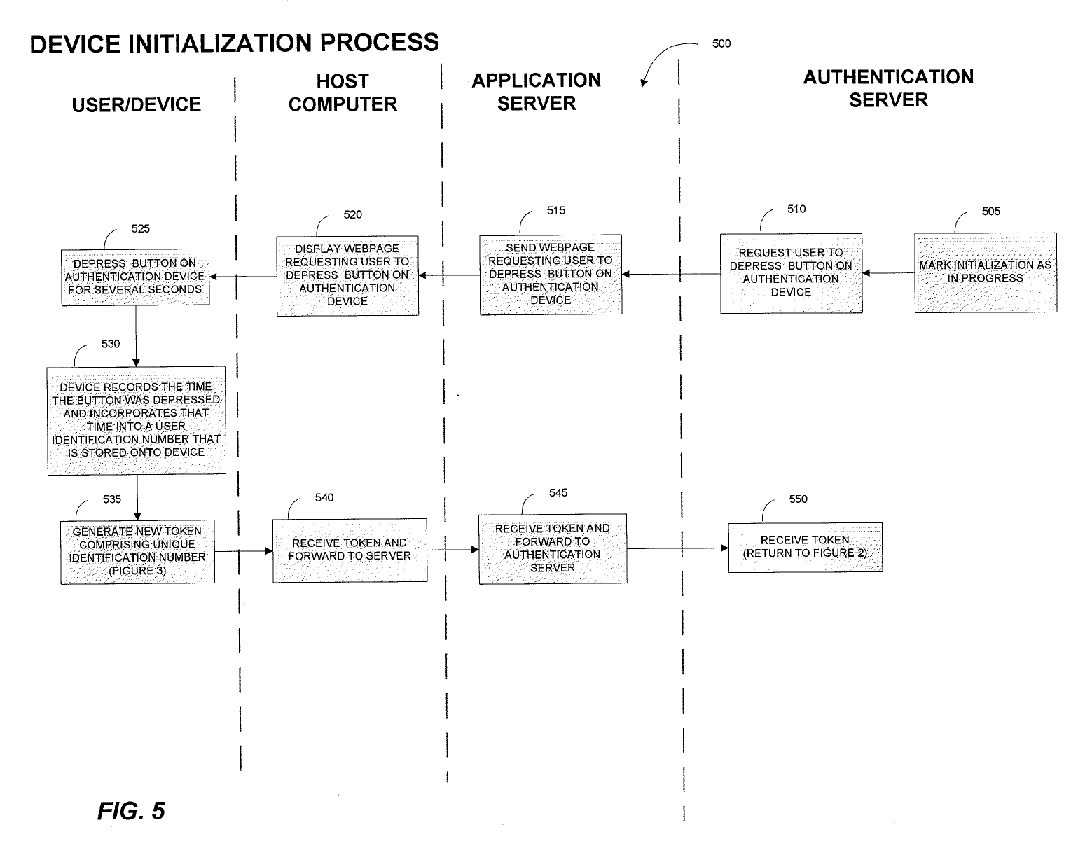

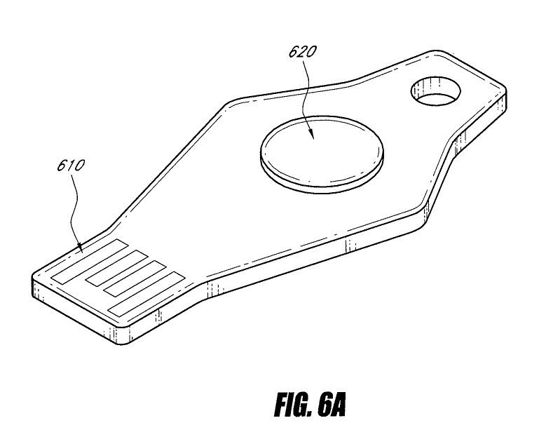

FIG. 5 illustrates one embodiment of a device initialization process 500 used to initialize the authentication device 105 with a user-determined value based on user action and to store the value on the authentication device. The value can be substantially unique by relying on an arbitrary user action to set the value and helps reduce cloning attacks on the authentication system at the factory since a potential attacker at the factory will not have the user identification number because the original authentication device 105 is un-initialized. Moreover, an attacker is unlikely to guess the correct user identification number since the number is based on an arbitrary user action.

In some embodiments, the value is determined by measuring the amount of time that a user activates an activation interface. For example, the user is asked to hold down a button on the activation device for a period of 4 seconds. The amount of time is then measured in millisecond intervals, such that each user's value is a little different. It is recognized that other user determined values and/or other activation interfaces may be used. For example, a finger print recognition interface may be used such that the user determined value relates to the user's unique fingerprint.

The device initialization process 500 comprises multiple processes that run on the authentication device 105, host computer 110, the application server 120, and/or the authentication server 140.

Beginning at block 505, the authentication server notes that the authentication device is being authenticated. At block 510, the authentication server 140 sends a request for the user to depress a button on the authentication device to the application server 120. At block 515, the application server 140 receives the request and sends a web page asking the user to depress the button and sends the webpage to the host computer 110; At block 520, the host computer 110 displays the received webpage.

At block 525, the user views the webpage and follows the instructions. In some embodiments, the instructions on the webpage could direct the user to depress the button for a specified number of seconds, such 1, 2, 3, 4, or more seconds. The user then depresses the button on the device by about the specified number of seconds. It is expected that users will hold down the button by varying amounts of time, generating substantially unique values. In certain embodiments, the user is directed to activate the activation interface 710 while a sound plays; a visual indication is displayed, such as a timer, progress bar, lighted LED, and/or other visual indication; the authentication device 105 vibrates; and/or some other indication is present.

At block 530, the authentication device 105 records the generated value as the user identification number stored on the device. In some embodiments, the authentication device 105 records the value using the activation interface module.

At block 535, the authentication device 105 generates a new token comprising the new identification number, such as via the token generation process.

At block 540, the host computer 110 receives the token and can forwards it to the application server 120. In some embodiments, the token is received via a set of keystrokes and/or other input generated by the authentication device 105. In addition, the token may be received as part of a URL that includes the token, where the URL comprises a web page address of an application server 120.

At block 550, the authentication server 140 receives the token and proceeds to validate the token. The device initialization process 500 ends and the authentication process continues at block 2955 of FIG. 2B or block 235 of FIG. 2A.

### VI. Additional Embodiments

While some embodiments of the disclosure have been described, these embodiments have been presented by way of example only, and are not intended to limit the scope of the present invention. Moreover, it is recognized and contemplated that one with ordinary skill in the art can implement the processes and systems to accommodate a plurality of entities that would like to implement the disclosed authentication systems and methods.

A person skilled in the art will recognize that while the embodiments discussed above refer to browsers and web pages, an application running on the host computer 110 can provide two-factor authentication by communicating with an application server 120 and/or authentication server 140. For example, an accounting program may request both a login and an authentication token to allow a user access to the information.

a. Computing System Information

In some embodiments, the systems, including the host computer 110, application server 120 and/or authentication server 140, may take the form of a computing system 800 (which can be a fixed system or mobile device) that is in communication with one or more computing systems and/or one or more data sources via one or more networks. The computing system 800 may be used to implement one or more of the systems and methods described herein. It is recognized that the functionality provided for in the components and modules of computing system 800 may be combined into fewer components and modules or further separated into additional components and modules.

i. Components

In one embodiment, the computing system 800 comprises a central processing unit (“CPU”) 804, which may comprise a conventional microprocessor. The computing system 800 further comprises a memory 805, such as random access memory (“RAM”) for temporary storage of information and/or a read only memory (“ROM”) for permanent storage of information, and a mass storage device 801, such as a hard drive, diskette, or optical media storage device. Typically, the modules of the computing system 800 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

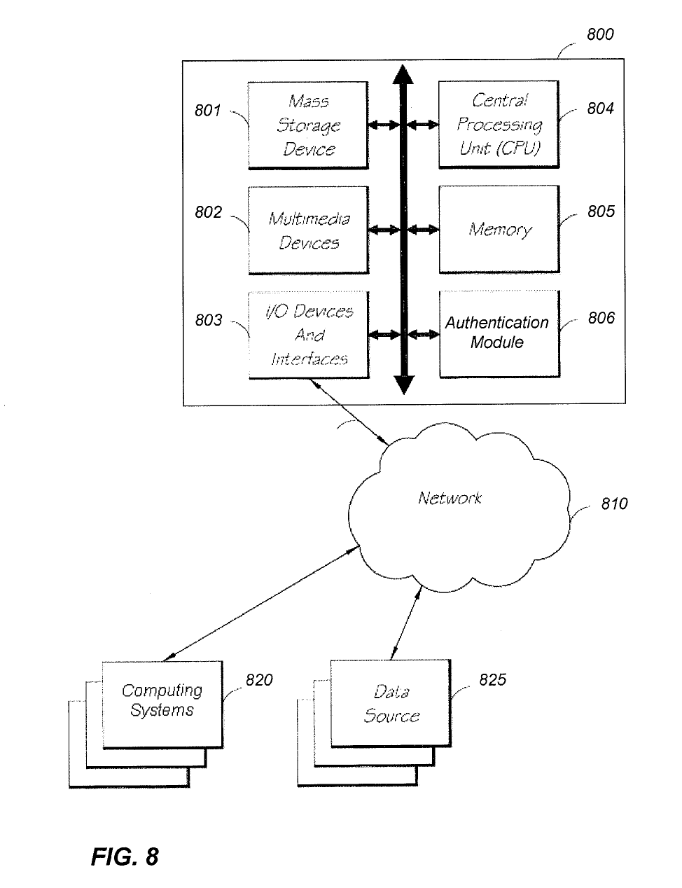

The computing system 800 also comprises one or more commonly available input/output (I/O) devices and interfaces 803, such as a keyboard, mouse, touch screen, roller ball, pen and stylus, trackball, voice recognition system, touchpad, and/or printer. In one embodiment, the I/O devices and interfaces 803 comprise one or more display devices, such as a monitor or other display screen, which allows the visual presentation of data to a user. More particularly, a display device provides for the presentation of GUIs, application software data, and web pages, for example. In the embodiment of FIG. 8, the I/O devices and interfaces 803 also provide a communications interface to various external devices. The computing system 800 may also comprise one or more multimedia devices 802, such as speakers, video cards, graphics accelerators, speakers, and microphones, for example.

ii. Authentication Module

In one embodiment, the computing system comprises an authentication module 806 that carries out the functions, methods, and/or processes described herein. The authentication module 806 may be executed on the computing system 800 by a central processing unit 804 discussed further below.

iii. Data Sources

The computing system 800 may also include one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a flat file database, an entity-relationship database, and object-oriented database, and/or a record-based database.

iv. Device/Operating System

The computing system 800 may run on a variety of computing devices, such as, for example, a server, a Windows server, an Structure Query Language server, a Unix server, a personal computer, a mainframe computer, a laptop computer, a cell phone, a personal digital assistant, a kiosk, an audio player, and so forth. The computing system 800 is generally controlled and coordinated by operating system software, such as z/OS, Windows 95, Windows 98, Windows NT, Windows 2000, Windows XP, Windows Vista, Linux, BSD, SunOS, Solaris, Palm OS, iPhone OS, Android OS, Windows Mobile, Symbian OS, BlackBerry OS, or other compatible operating systems. In Macintosh systems, the operating system may be any available operating system, such as MAC OS X. In other embodiments, the computing system 800 may be controlled by a proprietary operating system. Conventional operating systems control and schedule computer processes for execution, perform memory management, provide file system, networking, and I/O services, and provide a user interface, such as a graphical user interface (“GUI”), among other things.

v. Network Access

The computing system 800 may communicate with other systems via one or more networks 810, such as a LAN, WAN, or the Internet, for example, via a wired, wireless, or combination of wired and wireless, communication link. In addition, the computing system 800 may communicate with one or more data sources 825 via one or more networks 810.

b. Module

In some embodiments, the acts, methods, and processes described herein are implemented within, or using, software modules that are accessed by one or more general purpose computers. The software modules may be stored on or within any suitable computer-readable medium. It should be understood that the various steps may alternatively be implemented in-whole or in-part within specially designed hardware. The skilled artisan will recognize that not all calculations, analyses and/or optimization require the use of computers, though any of the above-described methods, calculations or analyses can be facilitated through the use of computers.

In general, the word “module,” as used herein, refers to logic embodied in hardware or firmware, or to a collection of software instructions, possibly having entry and exit points, written in a programming language, such as, for example, Java, C or C++, or the like. A software module may be compiled and linked into an executable program, installed in a dynamic link library, or may be written in an interpreted programming language such as, for example, BASIC, Perl, Lua, or Python. It will be appreciated that software modules may be callable from other modules or from themselves, and/or may be invoked in response to detected events or interrupts. Software instructions may be embedded in firmware, such as an EPROM and/or flash memory. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

c. Remote

It is recognized that the term “remote” may include data, objects, devices, components, and/or modules not stored locally, that is not accessible via the local bus. Thus, remote data may include a device which is physically stored in the same room and connected to the user's device via a network. In other situations, a remote device may also be located in a separate geographic area, such as, for example, in a different location, country, and so forth.

d. Other

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature in connection with an embodiment can be used in all other disclosed embodiments set forth herein. Thus, it is intended that the scope of the present invention herein disclosed should not be limited by the particular disclosed embodiments described above.

What is claimed is:

1. A portable authentication device comprising:
a memory configured to store:
a token encryption key;
a random number encryption key;
a random number seed;
a user identification number;
a sequence number
a device identification number; and
an activation interface configured to be activated by a user;
an activation interface module stored in the memory and configured to receive an indication that the authentication device is electronically connected to a computer and the activation interface has been activated;
a token generation module stored in the memory and configured to run on the computer after the authentication device has been electronically connected to the computer, the module including instructions to:
create a random number using the random number encryption key and the random number seed;
update the sequence number;
encrypt the random number, the user identification number, and the sequence number using the token encryption key to create a set of encrypted data and a checksum; and
create a token, the token comprising:
the device identification number;
the set of encrypted data; and
the checksum.

2. The portable authentication device of claim 1, wherein the portable authentication device is a USB device.

3. The portable authentication device of claim 1, wherein the memory includes at least one of SDRAM, EEPROM and flash.

4. The portable authentication device of claim 1, wherein the memory is configured to store a nonce encryption key and a nonce seed, and wherein the token generation module further includes instructions to create a random nonce using the nonce encryption key and the nonce number seed, to encrypt the random number, the user identification number, and the sequence number also using the random nonce, and to create the token also including the random nonce.

5. The portable authentication device of claim 4, wherein the portable authentication device is a USB device

6. The portable authentication device of claim 1, wherein the activation interface is a button.

7. The portable authentication device of claim 1, wherein the token generation module is further configured to auto run after being electronically connected with the computer.

8. The portable authentication device of claim 1, wherein the token generation module is further configured to run after the activation interface is activated by the user.

9. The portable authentication device of claim 1, wherein the memory is further configured to store a web address.

10. The portable authentication device of claim 9, wherein the token generation module is further configured to open a browser program on a computer using the web address and the token.

11. The portable authentication device of claim 10, wherein the token generation module is further configured to:
create a uniform resource locator using the web address and the token; and
to pass the uniform resource locator to the web browser.

12. The portable authentication device of claim 1, wherein the activation interface module is further configured to determine an amount of time the user has activated the activation interface and update the user identification number to be the amount of time.

13. The portable authentication device of claim 12, wherein the amount of time is measured at least in millisecond intervals.

14. The portable authentication device of claim 12, wherein the activation interface module is further configured to send a token comprising the updated user authentication number to an application server to be sent to an authentication server.

15. The portable authentication device of claim 1, wherein the token generation module is further configured to update the sequence number by incrementing the value of the sequence number before the token is generated.

16. The portable authentication device of claim 1, wherein the token generation module is further configured to update the sequence number by incrementing the value of the sequence number after the token is generated.

17. A computer-implemented method for electronically generating an authentication token, the method comprising:
receiving a random number encryption key, a token encryption key, a random number seed, a user identification number, a sequence number, and a device identification number from a portable authentication device;
creating, by a processor, a random number using a the random number encryption key and the random number seed;
updating, by a processor, the sequence number;
encrypting, by a processor, the random number, the user identification number, and the sequence number using the token encryption key to create a set of encrypted data and a checksum; and
creating, by a processor, a token, the token comprising:
the device identification number;
the set of encrypted data; and
the checksum.

18. The computer-implemented method of claim 17 further comprising:
receiving a web address from the portable authentication device;
creating a uniform resource locator using the web address and the token; and
passing the uniform resource locator to the web browser.

19. The computer-implemented method of claim 17, wherein the portable authentication device is a USB device.

20. The computer-implemented method of claim 17 further comprising:
receiving a nonce encryption key and a nonce seed; and
creating, by a processor, a random nonce using the nonce encryption key and the nonce number seed;
wherein encrypting the random number, the user identification number, and the sequence number also uses the random nonce and the token includes the random nonce.

21. A computer-implemented storage medium having a computer program stored thereon for causing a computer to process computer-program code by performing the method of claim 17 when such program is executed on the computer.

22. An authentication server system comprising:
a memory; and
an authentication module stored on the memory, the authentication module configured to:
receive an authentication token, the authentication token comprising:
a device identification number; and
a set of encrypted data;
use the device identification number to retrieve a token encryption key;
decrypt the set of encrypted data using the token encryption key to obtain a random number, a user identification number, and a sequence number;
verify the sequence number is valid;
verify the random number is correct; and
verify the user identification number is correct.

23. The authentication server system of claim 22, wherein the token further comprises a checksum, and the authentication module is further configured to verify the token using the checksum.

24. The authentication server system of claim 22, where the authentication token further comprises a random nonce number, and the authentication module is further configured to decrypt the set of encrypted data using the token encryption key also using the random nonce number.

25. The authentication server system of claim 22, wherein the authentication module is further configured to determine whether the user identification number has been initialized and if not, then to initialize the portable authentication device.

26. The authentication server system of claim 22, wherein the authentication module is configured to initialize the portable authentication device by sending instructions to have the user activate an activation interface on the portable authentication device for a predetermined time period, receiving a time value indicating the length of time the user activated the activation interface, and updating the user identification number to be the received time value.

27. The authentication server system of claim 26, wherein the length of time is measured at least in millisecond intervals.

28. A computer-implemented method for electronically authenticating a token, the method comprising:
receiving an authentication token, the authentication token comprising:
a device identification number; and
a set of encrypted data;
using the device identification number to retrieve a token encryption key;
decrypting the set of encrypted data using the token encryption key to obtain a random number, a user identification number, and a sequence number;
verifying the sequence number is valid;
verifying the random number is correct; and
verifying the user identification number is correct.

29. The method of claim 28, wherein the authentication token is generated by a portable authentication device.

30. The method of claim 28, wherein after initialization, the user identification number indicates an amount of time a user activated an activation device on the portable authentication device.

31. The method of claim 28, wherein the authentication token further comprises a random nonce number and decrypting the set of encrypted data also uses the random nonce number.

32. A computer-implemented storage medium having a computer program stored thereon for causing a computer to process computer-program code by performing the method of claim 28 when such program is executed on the computer.

33. A method for initializing an authentication device, the method comprising:
activating an activation interface;
recording an amount of time the activation interface is activated; and
updating a user identification number to be the amount of time.

34. The method of claim 33, wherein the amount of time is measured at least in millisecond intervals.
